(19) United States
(12) Patent Application Publication
(10) Pub. No.: US 2026/0200325 A1
(43) Pub. Date: Jul. 16, 2026

(54) SYSTEMS AND METHODS FOR HYDROGEN TANK ASSEMBLY DIAGNOSTICS

(71) Applicant: Hyroad Networks LLC, Austin, TX (US)

(72) Inventors: Rahul Shetty, Chandler, AZ (US); Renju Zacharia, Gilbert, AZ (US)

(21) Appl. No.: 19/337,024

(22) Filed: Sep. 23, 2025

Related U.S. Application Data
(60) Provisional application No. 63/697,943, filed on Sep. 23, 2024.

(51) Int. Cl. B60L 3/00; B60K 15/01; B60K 15/03; B60L 50/70; G07C 5/08; H01M 8/04082; H01M 8/0438; H01M 8/04664; H01M 8/04746; H01M 8/04992

(52) U.S. Cl. CPC B60L 3/00; G07C 5/0825; G07C 5/0833; H01M 8/04201; H01M 8/04388; H01M 8/04664; H01M 8/04753; H01M 8/04992; B60K 15/01; B60K 15/03; B60K 2015/03217; B60K 2015/03315; B60L 50/70; H01M 2250/20

(57) ABSTRACT

The present disclosure provides a hydrogen storage system for a fuel cell electric vehicle (FCEV) that includes a controller in electronic communication with a plurality of pressure sensors, each pressure sensor coupled to a hydrogen storage tank of a plurality of hydrogen storage tanks and a non-transitory computer-readable storage medium in electronic communication with the controller. The controller may be capable of identifying a stuck closed on tank valve (OTV) fault and a tank leak fault using a plurality of pressure measurements from the plurality of pressure sensors.

### CROSS REFERENCE TO RELATED APPLICATION

This application claims priority to, and the benefit of, U.S. Provisional Patent Application No. 63/697,943 filed on Sep. 23, 2024 entitled “SYSTEMS AND METHODS FOR HYDROGEN TANK ASSEMBLY DIAGNOSTICS.” The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to systems for monitoring hydrogen gas, and more particularly, to monitoring hydrogen gas used as fuel in, for example, fuel cell vehicles.

### BACKGROUND

Fuel cell electric vehicles (FCEVs) facilitate oxidation-reduction (redox) reactions between oxygen and hydrogen in a fuel cell system to generate electrical energy. More specifically, as hydrogen enters the fuel cell system, electrons are disassociated from hydrogen molecules and passed through an external circuit in order to perform work, while protons are passed through an internal membrane. At the cathode, the protons recombine with the electrons and oxygen in an exothermic reaction to form water and heat, which are exhausted to the external environment along with some amount of unreacted hydrogen and air. Given the care with which hydrogen gas should be handled, monitoring fuel storage systems that house hydrogen gas is important for safety, among other things. Accordingly, improved systems and methods remain desirable.

### SUMMARY

A hydrogen storage system for a fuel cell electric vehicle (FCEV) may comprise a controller in electronic communication with a plurality of pressure sensors, each pressure sensor coupled to a hydrogen storage tank of a plurality of hydrogen storage tanks, and a non-transitory computer-readable storage medium in electronic communication with the controller, having instructions stored thereon that, in response to execution by the controller, cause the controller to perform operations comprising, receiving, by the controller, a plurality of pressure measurements from the plurality of pressure sensors, determining, by the controller, a median pressure value of the plurality of pressure measurements, calculating, by the controller, differences between the median pressure value and each pressure measurement of the plurality of pressure measurements. In response to finding that at least one difference is less than a first pressure threshold, the operations may further comprise transmitting, by the controller, a stuck closed on tank valve (OTV) fault, and, in response to finding that at least one difference is greater than a second pressure threshold, transmitting, by the controller, a tank leak fault.

In various embodiments, each hydrogen storage tank of the plurality of hydrogen storage tanks may comprise an end plug (EP) and an OTV. The EP and the OTV may be in fluid communication with an internal volume of the hydrogen storage tank. The pressure sensor may be included in at least one of the EP or the OTV. The first pressure threshold may be determined based on a pressure in at least one of a fuel cell supply line, a manifold, or a plumbing system. The fuel cell supply line, the manifold, and the plumbing system may be in fluid communication with the hydrogen storage tanks when OTVs coupled to the hydrogen storage tanks are open. The operations may further comprise communicating, by the controller, the stuck closed OTV fault or the tank leak fault to a second controller. The second controller may comprise one of a vehicle control module (VCM) or a vehicle head unit (VHU).

An article of manufacture may comprise a tangible, non-transitory computer-readable storage medium in electronic communication with a controller, having instructions stored thereon that, in response to execution by the controller, cause the controller to perform operations comprising, receiving, by the controller, a plurality of pressure measurements from a plurality of pressure sensors, each pressure sensor coupled to a hydrogen storage tank of a plurality of hydrogen storage tanks, determining, by the controller, a median pressure value of the plurality of pressure measurements, calculating, by the controller, differences between the median pressure value and each pressure measurement of the plurality of pressure measurements, determining, by the controller, the absolute value of the difference between the first pressure and the second pressure to yield an absolute pressure difference. In response to finding that at least one difference is less than a first pressure threshold, the operations may further comprise transmitting, by the controller, a stuck closed on tank valve (OTV) fault, and in response to finding that at least one difference is greater than a second pressure threshold, transmitting, by the controller, a tank leak fault.

In various embodiments, the operations may further comprise communicating, by the controller, an audible or visual alert to an operator in response to the stuck closed OTV fault. The article of manufacture may further comprise an OTV fluidly coupled to each hydrogen storage tank. The instructions may further comprise commanding, by the controller, each OTV to a closed position in response to the tank leak fault. The article of manufacture may further comprise determining the median pressure value of the plurality of pressure measurements comprises calculating a mean pressure value of a first pressure measurement and a second pressure measurement when the plurality of hydrogen storage tanks comprises an even number of tanks. The plurality of hydrogen storage tanks may comprise five hydrogen storage tanks.

A method may comprise receiving, by a controller, a plurality of pressure measurements from a plurality of pressure sensors, each pressure sensor coupled to a hydrogen storage tank of a plurality of hydrogen storage tanks, determining, by the controller, a median pressure value of the plurality of pressure measurements, calculating, by the controller, differences between the median pressure value and each pressure measurement of the plurality of pressure measurements, determining, by the controller, the absolute value of the difference between the first pressure and the second pressure to yield an absolute pressure difference. In response to finding that at least one difference is less than a first pressure threshold, the method may further comprise transmitting, by the controller, a stuck closed on tank valve (OTV) fault, and in response to finding that at least one difference is greater than a second pressure threshold, transmitting, by the controller, a tank leak fault.

In various embodiments, the method may further comprise communicating, by the controller, the stuck closed OTV fault or the tank leak fault to a second controller. The second controller may comprise at least one of a vehicle control module (VCM) or a vehicle head unit (VHU). The method may further comprise commanding, by the controller, a plurality of OTVs associated with the plurality of hydrogen storage tanks to closed positions in response to the tank leak fault. The method may further comprise updating, by the VHU, an amount of fuel available based on a fuel remaining in the tank having the stuck closed OTV fault. The method may further comprise, changing, by the VCM, an operating mode of a vehicle comprising the plurality of hydrogen storage tanks in response to the tank leak fault.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an FCEV, in accordance with various embodiments;

FIG. 2 illustrates a bottom view of an FCEV, in accordance with various embodiments;

FIGS. 3A and 3B illustrate a hydrogen storage system, in accordance with various embodiments;

FIG. 4 illustrates a hydrogen tank assembly diagnostic system, in accordance with various embodiments;

FIG. 5 illustrates a hydrogen tank assembly diagnostic, in accordance with various embodiments;

FIGS. 6A and 6B illustrate methods for confirming the existence of an OTV stuck closed fault using temperature data, in accordance with various embodiments;

FIG. 7 illustrates a graph of hydrogen tank assembly tank pressures and temperatures over time, in accordance with various embodiments; and

FIGS. 8A and 8B illustrate exemplary hydrogen tank assembly pressure distributions, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

In the context of the present disclosure, methods, systems, and articles may find particular use in connection with medium- and heavy-duty FCEVs. However, various aspects of the disclosed embodiments may be adapted for performance in a variety of other systems, including gasoline/electric hybrid vehicles, compressed natural gas (CNG) vehicles, hythane (mix of hydrogen and natural gas) vehicles, and/or the like. Accordingly, numerous applications of the present disclosure may be realized.

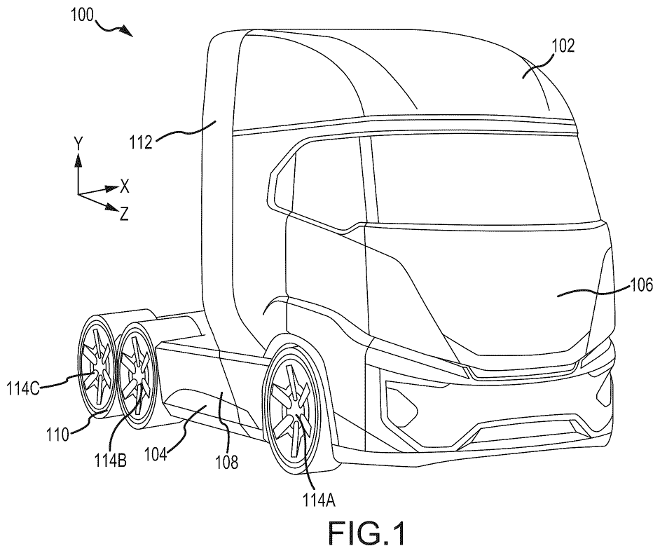

Accordingly, with reference to FIG. 1, FCEV 100 is illustrated from a top perspective view, in accordance with various embodiments. As illustrated in FIG. 1, FCEV 100 is a heavy-duty FCEV. FCEV 100 is a tractor unit which may tow a trailer unit configured to hold and transport cargo. FCEV 100 may comprise a class 8, class 7, class 6, or any other weight classification of tractor-trailer combination. As described herein, FCEV 100 extends in a longitudinal direction along the Z-axis from a rear of FCEV 100 to a front of FCEV 100. FCEV 100 extends in a transverse direction along the X-axis from a passenger side of FCEV 100 to a driver side of FCEV 100. Finally, FCEV 100 extends in a vertical direction along the Y-axis from a ground surface on which FCEV 100 drives to a top of FCEV 100.

FCEV 100 comprises a cab 102 supported by a chassis 104. Cab 102 may be configured to shelter one or more vehicle operators or passengers from the external environment. In various embodiments, cab 102 comprises a door configured to allow ingress and egress into and from cab 102, one or more seats, a windshield, and numerous accessories configured to improve comfort for the operator and/or passenger(s). As illustrated in FIG. 1, FCEV 100 comprises a cab-over or cab-forward style tractor unit, but is not limited in this regard and may comprise any style of tractor unit including a conventional or American cab style tractor unit.

Chassis 104, otherwise known as the vehicle frame, is configured to support various components and systems of FCEV 100 including cab 102. Chassis 104 may comprise a ladder-like structure with various mounting points for FCEV 100's suspension, powertrain, energy storage systems (ESS) (for example, fuel cell system(s) and/or battery system(s)), and other systems. Chassis 104 supports and is coupled to a fuel cell system 106 which may be configured to facilitate an electrochemical reaction in order to generate electrical energy that can be used to drive FCEV 100 and operate electric components and systems of FCEV 100. Chassis 104 may be covered by one or more side covers 108 configured to provide corrosion-resistance and improved aerodynamics along the sides of FCEV 100. FCEV 100 further comprises wheels 110 comprising one or more tires coupled to one or more axles 114 and configured to roll along a driving surface. In various embodiments, FCEV 100 comprises a pair of single wheels coupled to a front axle 114A and a pair of dual wheels coupled to two rear axles (first rear axle 114B and second rear axle 114C). One or more of the axles may be driven. For example, in various embodiments, FCEV 100 may comprise a 6×2 configuration with a single driven axle; however, FCEV 100 is not limited in this regard and may comprise a 4×2, 6×4, 6×6, or other suitable configuration. In various embodiments, FCEV 100 may further comprise a hydrogen storage system 112 configured to contain and deliver hydrogen fuel to fuel cell system 106.

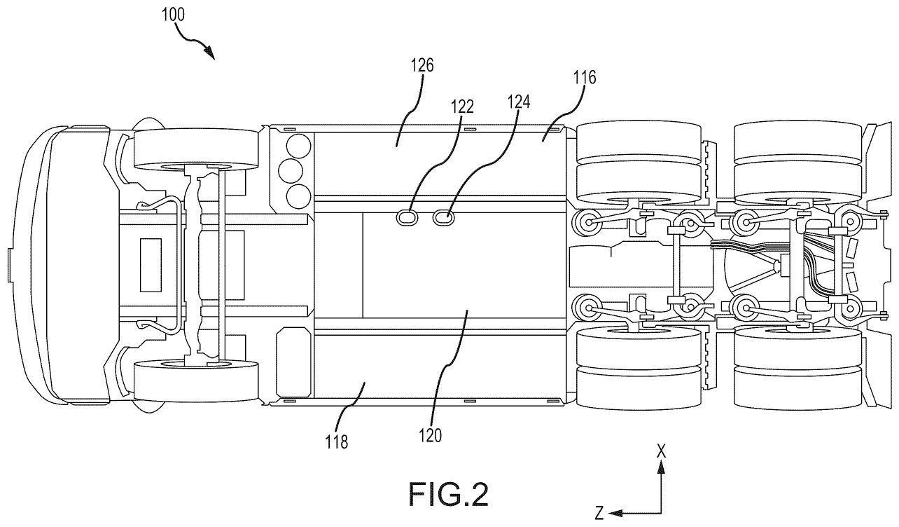

With reference to FIG. 2, FCEV 100 is illustrated from a bottom view, in accordance with various embodiments. In various embodiments, FCEV 100 comprises an undercarriage 116 that comprises a first outboard skid plate 118, an inboard skid plate 120, and a second outboard skid plate 126. First outboard skid plate 118 is positioned adjacent to the passenger side of FCEV 100 and is coupled to a first frame rail of chassis 104 on a first side and coupled to a first side cover 108 on a second side. Similarly, second outboard skid plate 126 is positioned adjacent to the driver side of FCEV 100 and is coupled to a second frame rail of chassis 104 on a first side and coupled to a second side cover 108 on a second side. Inboard skid plate 120 is positioned between the first outboard skid plate 118 and the second outboard skid plate 126 and is coupled to the first frame rail of chassis 104 on a first side and coupled to the second frame rail of chassis 104 on a second side.

Inboard skid plate 120 comprises a first exhaust aperture 122 and a second exhaust aperture 124 adjacent to and rearward of first exhaust aperture 122. As illustrated, first exhaust aperture 122 and second exhaust aperture 124 extend through inboard skid plate 120 adjacent to second outboard skid plate 126. More specifically, first exhaust aperture 122 and second exhaust aperture 124 are located adjacent to and inboard of the second frame rail of chassis 104; however, the positioning of first exhaust aperture 122 and second exhaust aperture 124 is not limited in this regard, and the apertures may be positioned adjacent to and inboard of the first frame rail of chassis 104, centered in the transverse direction on inboard skid plate 120, or positioned at any suitable location in the transverse location on first outboard skid plate 118 or second outboard skid plate 126. Moreover, while illustrated as comprising two separate exhaust apertures, FCEV 100 is not limited in this regard and may comprise a single exhaust aperture in various embodiments.

In various embodiments, first exhaust aperture 122 and second exhaust aperture 124 are configured to permit exhaust gases and water to exit fuel cell system 106 (and FCEV 100) and be delivered to the external environment (for example, to the ground). More specifically, as fuel cell system 106 operates, fuel cell system 106 generates water and/or water vapor and heat to be exhausted to the external environment along with some amount of unreacted hydrogen and air. In various embodiments, first exhaust aperture 122 and second exhaust aperture 124 overlap with fuel cell system 106 in the transverse direction and are positioned rearward of fuel cell system 106. First exhaust aperture 122 and second exhaust aperture 124 may be located such that one or more exhaust ducts extending between fuel cell system 106 and the exhaust apertures occupy reduced and/or minimized volume on FCEV 100.

The storage, fueling, defueling, and use of compressed gases such as hydrogen gas (H₂) in a vehicle may be associated with enhanced energy efficiency, improved environmental impact profile, and decreased reliance on fossil fuels. As discussed above, hydrogen gas may be combined with oxygen in a fuel cell to yield electrical energy and water. This reduces or eliminates the need for a vehicle to consume fossil fuels directly and/or emit pollutants such as NOₓ, SOₓ, CO₂, and various hydrocarbons into the atmosphere, such as would occur in a fossil fuel burning engine, such as a compression ignition engine (e.g., Diesel engine) or internal combustion engine (“ICE” e.g., gasoline powered engine such as an Otto cycle ICE and/or Atkinson cycle ICE).

FCEV 100 may be operated in various modes, also referred to as an operational status or condition. For example, FCEV 100 may operate in the following modes: off mode (supports lighting, safety features), accessory mode (body, chassis, safety, HVAC), remote run mode (remote start of the vehicle to thermally condition systems, including cabin), run mode (full operation), fueling mode (security, lighting, HVAC during fueling), service mode (all vehicle functionality and vehicle diagnostics data), autonomous mode (similar to run mode but autonomously controlled), drone mode (similar to run mode but control of vehicle is performed remote to the vehicle), and semi-autonomous mode (similar to autonomous mode but only certain controls are performed autonomously while others are configured to be performed by an operator). Fueling mode comprises a mode whereby hydrogen gas is conducted into hydrogen storage system 112. A fueling station may connect to hydrogen storage system 112 via one or more fluid connections. Further, a fueling station may comprise one or more wired or wireless interfaces that communicate data to and from FCEV 100 and the fueling station. Other fueling stations, however, do not have such data communication links. Defueling mode may comprise a mode whereby hydrogen gas is released from hydrogen storage system 112 and either fed to a fuel cell or vented to the ambient environment. Drive-ready mode or status comprises a mode wherein FCEV 100 remains stationary, but one or more power systems may be active and FCEV 100 is ready to be driven. Drive-ready mode or status may be comparable to the “idle” state of a conventional fossil fuel burning vehicle. Drive mode comprises a state whereby FCEV 100 is in motion under its own power. One or more fuel cells may be functioning during drive mode, though drive mode also includes a state where FCEV 100 is traveling under battery stored power. Drive mode is thus characterized by current motion of FCEV 100. Off mode comprises a mode where the FCEV 100 is stationary and awaiting to be put into another mode. Certain systems of FCEV 100 may be active, but FCEV 100 would typically be considered “off” in off mode. FCEV 100 may be operated during driving by a user onboard FCEV 100. However, in various embodiments, FCEV 100 may be operated remotely by a remote user in electronic communication with FCEV 100 to provide driving commands. In still further embodiments, FCEV 100 is operated autonomously through the use of self-driving logic and onboard sensors, such as cameras, LiDAR arrays, IR sensors, and other optical and audio input devices. Park preparation condition comprises a state where FCEV 100 is preparing to enter park mode. Park preparation condition may occur in response to a command from a driver or remote operator to place FCEV 100 in park. A low fuel cell power demand condition comprises a state where power demand from the fuel cell is relatively low. In various embodiments, a low fuel cell power demand condition may comprise a time or time period where power demand on the fuel cell is from 0.5%-20% maximum fuel cell power output capacity, and/or from 5%-15% maximum fuel cell power output capacity, and/or from 8%-12% maximum fuel cell power output capacity.

Similar to how a fossil fuel burning vehicle carries onboard fuel in the form of flammable petroleum products, FCEVs typically carry hydrogen gas. Like petroleum products, hydrogen gas is flammable. Thus, movement and storage of hydrogen gas should be carefully controlled and, beneficially, monitored accordingly. Moreover, hydrogen gas has a negative Joule-Thompson coefficient at temperatures typically associated with the Earth's surface (i.e., between −20° F. (−28° C.) and 120° F. (49°°C.)). This means that hydrogen gas increases in temperature both (i) upon being moved into a tank, and (ii) upon being expelled from a tank through an orifice. Depending upon ambient temperature and the velocity of the gas flowing through the orifice, this increase in temperature may create a hazardous condition. Thus, fueling and defueling a hydrogen gas tank may become hazardous if not properly controlled. Further, should the integrity of the tank become compromised, such as in the event of a fire or vehicular accident, the hydrogen gas stored therein may desirably be vented to prevent or reduce the severity of a fire. Moreover, given the permeability and diffusivity of hydrogen, design and manufacturing defects associated with hydrogen tanks can result in hydrogen leaking from the tanks and the tanks may desirably be monitored accordingly. Finally, one or more components associated with the hydrogen tanks (e.g., solenoid valves, on tank valves, others), may be prone to fail, thereby impacting the ability to selectively permit or prevent the flow of hydrogen to the fuel cell system. These complexities of moving, storing, and using hydrogen gas on a vehicle have traditionally inhibited the adoption of FCEVs, which thus inhibits the transition from fossil fuel burning vehicles to cleaner alternatives. In that regard, improved monitoring and management for hydrogen gas tanks on vehicles is associated with improved environmental impact and safer roadways and fueling stations.

FCEVs may comprise more than one tank of hydrogen gas arranged in an array. The array may be managed as a system, plumbed together to fuel and defuel as a unit. However, the tanks may experience varying conditions from one another during use. Consequently, the array may benefit from a tank-by-tank approach to management. In that regard, managing an array as a whole eases interaction with other onboard systems, while closely managing each tank in the array improves safety and performance. To facilitate management, sensors such as temperature and pressure sensors may be employed to sense temperature and pressure. The ideal gas law, PV=nRT, relates P=pressure, V=volume, T=temperature, n=number of moles of a gas, and the R=ideal gas constant. The ideal gas law may be used as an approximation for the behavior of hydrogen gas, though of course real gases behave differently than an ideal gas. Thus, from the sensed pressure and temperatures, density of the gas stored therein may be derived. Density of hydrogen gas may be used to monitor for safety and from the known tank volume, the mass hydrogen stored, among other things.

A physical property sensor, such as a temperature sensor or pressure sensor, may become unreliable over its lifetime. Such a sensor may become “noisy,” meaning that the sensor displays wide variations in signal despite monitoring a steady state system. For example, given a steady state of pressure, a sensor that displays a 15% variance in pressure measurement in measurements taken 1 second apart may be considered “noisy.” Sensors may also fail over time and benefit from replacement. In that regard, vehicular systems may desirably be robust enough to maintain functionality even with at least one pressure and/or temperature sensors having failed or becoming excessively noisy.

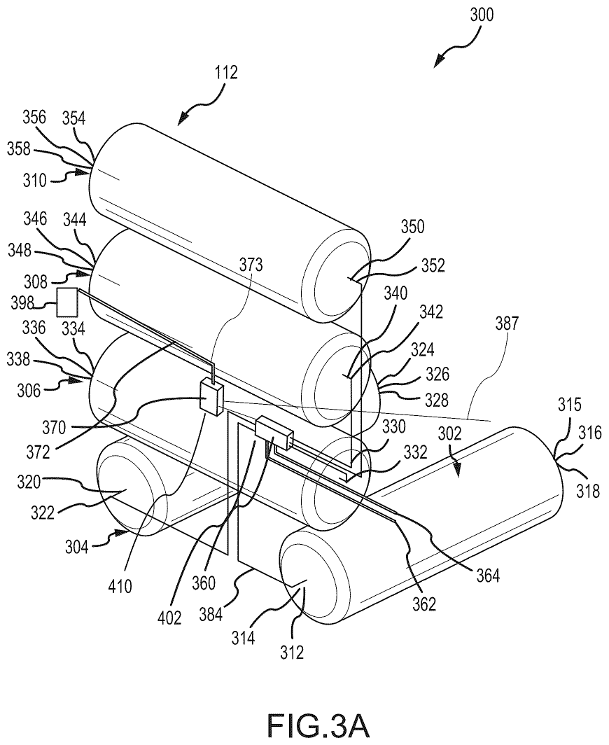

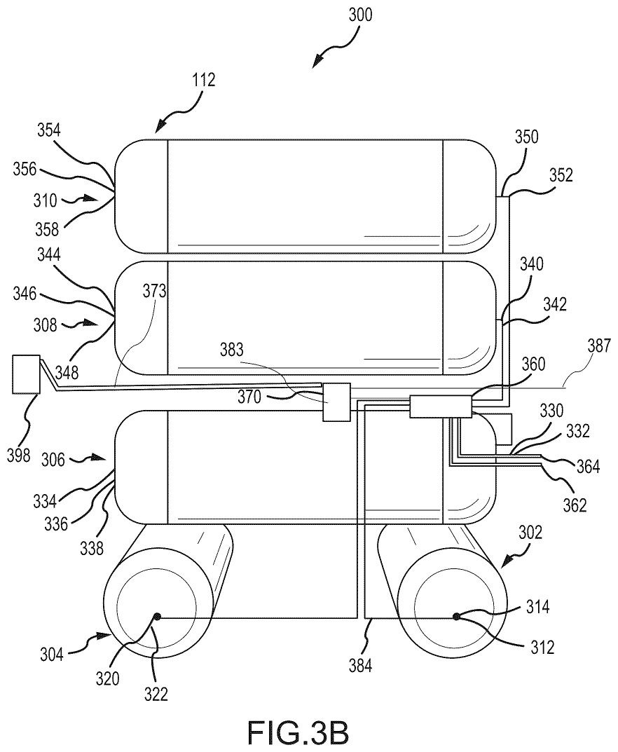

Referring now to FIGS. 3A and 3B, hydrogen storage system 112 is shown including hydrogen storage tank assembly diagnostic system 300. Hydrogen storage tank assembly diagnostic system 300 comprises various temperature and pressure sensors in electrical, wireless, and/or logical communication with controller 402 as well as various valves that are also in electrical, wireless, and/or logical communication with controller 402.

Hydrogen storage system 112 receives hydrogen gas from input 362 and input 364. Hydrogen gas may be in compressed form. Hydrogen gas is received into manifold 360 and distributed to tanks 302, 304, 306, 308, and 310 via plumbing system 384.

Tanks 302, 304, 306, 308, and 310 comprise a plurality of type III or type IV pressurized vessels. Tanks 302, 304, 306, 308, and 310 may be positioned at the rear of cab 102 and/or on either side of chassis 104 between the frame rails of chassis 104 and side covers 108. In various embodiments, the tanks 302, 304, 306, 308, and 310 may be configured to contain pressurized gaseous or liquid hydrogen at a pressure of between approximately 350 bar (35 MPa) to 875 bar (87.5 MPa), or between approximately 500 (50 MPa) and 750 bar (75 MPa), or approximately 600 bar (60 MPa). In embodiments where liquid hydrogen is employed, the pressure may be between 2 bar (0.2 MPa) and 30 bar (3 MPa). As a result, tanks 302, 304, 306, 308, and 310 may be configured to deliver hydrogen along a downward pressure gradient to a fuel cell system without the need for one or more compressors that may otherwise consume electrical energy and adversely impact vehicle range. In various embodiments where liquid hydrogen is employed, an additional compressor may be employed to pressurize the hydrogen to suit the incoming pressure specifications of the fuel cell. In various embodiments, such as those utilizing liquid hydrogen storage, a heat exchanger may be employed to thermally condition the hydrogen to suit the incoming temperature specifications of the fuel cell.

Manifold 360 may fuel one or more of tanks 302, 304, 306, 308, and 310 in a selectable manner. Regulator 370 receives hydrogen gas from tanks 302, 304, 306, 308, and 310 via manifold 360 and plumbing system 384 and conducts hydrogen gas to a fuel cell. A fueling system may be in communication with controller 402 to facilitate hydrogen gas flow, though in various embodiments no such communication may occur. Tanks 302, 304, 306, 308, and 310 are illustrated having tanks 304 and 302 oriented perpendicular to tanks 306, 308, and 310, though other spatial configurations are contemplated herein. Vent system 387 is coupled to regulator 370. In various embodiments, additional lines fluidly coupled to each of tanks 302, 304, 306, 308, and 310 are configured with a mechanical switch to vent in the event of an emergency. Regulator 370, being in fluid communication with manifold 360 and thus each of tanks 302, 304, 306, 308, and 310, can experience pressure from hydrogen gas from all tanks. Regulator 370 may be equipped with a mechanical vent valve (vent valve 410) that is mechanically biased (e.g., biased by a spring) to the closed position. In the event the collective pressure from tanks 302, 304, 306, 308, and 310 overcomes the mechanical bias, regulator 370 may vent hydrogen gas to the ambient environment. Vent valve 410 thus fluidly couples the plumbing of vent system 387 with the ambient environment. In response to the hydrogen gas pressure from tanks 302, 304, 306, 308, and 310 falling below the mechanical bias force, regulator 370 may close the vent valve via the mechanical bias force. Vent system 387 thus fluidly couples hydrogen storage system 112 to the ambient environment. In the event that hydrogen storage system 112 would benefit from emptying hydrogen gas, vent system 387 may be activated in this manner to conduct hydrogen gas away from each of tanks 302, 304, 306, 308, and 310 into the ambient environment where the hydrogen gas may be less of a hazard, for example in the event of over pressurization.

Hydrogen storage system 112 may comprise valves that are manually, electromechanically, hydraulically, and/or pneumatically actuated. In that regard, a valve assembly may comprise a valve and an electromechanical device that is in electrical, wireless, and/or logical communication with controller 402 such that controller 402 may issue commands to the electromechanical device to open, close, partially open, or partially close the valve. Various temperature and pressure measurements may be transmitted to controller 402 at various intervals. These intervals are selectable, and may be from 1 millisecond (ms) to 500 ms, from 1 ms to 1 second, and/or from 50 ms to 2 seconds.

Tank 302 comprises an on tank valve (OTV) 312 that comprises OTV temperature sensor 314. OTV 312 receives hydrogen gas from plumbing system 384. End plug (EP) 315 comprises temperature sensor 316 and pressure sensor 318. Tank 304 comprises OTV 320 that further comprises OTV temperature sensor 322. EP 324 comprises temperature sensor 326 and pressure sensor 328. Tank 306 comprises OTV 330 that further comprises OTV temperature sensor 332. EP 334 comprises temperature sensor 336 and pressure sensor 338. Tank 308 comprises OTV 340 that further comprises OTV temperature sensor 342. EP 344 comprises temperature sensor 346 and pressure sensor 348. Tank 310 comprises OTV 350 that further comprises OTV temperature sensor 352. EP 354 comprises temperature sensor 356 and pressure sensor 358. In various embodiments, each OTV may further comprise a pressure sensor. In that regard, each of OTVs 312, 320, 330, 340, and 350 may comprise a pressure sensor.

It should be noted that OTV temperature sensors 314, 322, 332, 342, and 352 may not necessarily observe the same temperature observed by EP temperature sensors 316, 326, 336, 346, and 356 at the same time. As hydrogen gas enters or exits a tank, localized heat transfer, some of which is associated with compressing hydrogen gas or expanding hydrogen gas, may affect the localized temperatures observed at either end of the tank. In that regard, some difference in temperature readings between OTV temperature sensors 314, 322, 332, 342, and 352 and EP temperature sensors 316, 326, 336, 346, and 356 is expected, especially during non-steady state times, such as during fueling and/or defueling/discharge to the fuel cell system.

Regulator 370 is fluidly coupled to fuel cell supply line 373. In this manner, regulator 370 is able to regulate flow of hydrogen gas to fuel cell 398. Fuel cell 398, as discussed above, produces electrical energy from the hydrogen gas to power FCEV 100. As fuel cell 398 consumes hydrogen gas to produce electrical energy, if all tanks 302, 304, 306, 308, and 310 are in a closed position, and thus not sending additional hydrogen gas flow to regulator 370, the pressure in fuel cell supply line 373, manifold 360, and/or plumbing system 384 will decrease as hydrogen gas is consumed but not replenished from tanks 302, 304, 306, 308, and 310. Opening any of OTVs 312, 320, 330, 340, and/or 350 will allow flow of hydrogen gas into fuel cell supply line 373, manifold 360, and/or plumbing system 384 and thus raise the pressure inside these components. Regulator 370 comprises one or more pressure sensors 383 capable of measuring the pressure of fuel cell supply line 373, manifold 360, and/or plumbing system 384.

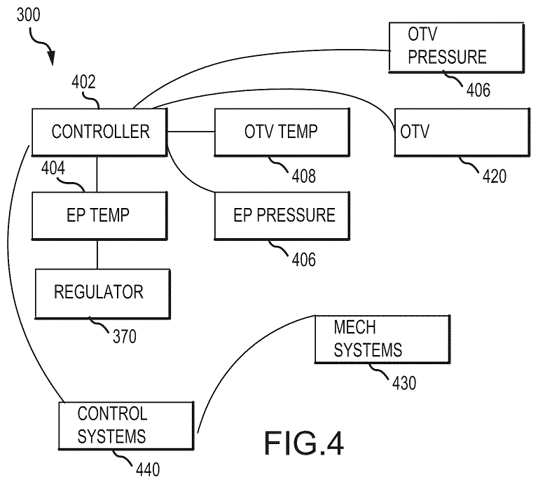

With reference now to FIG. 4, hydrogen tank assembly diagnostic system 300 is illustrated schematically. Controller 402 comprises a processor or other hardware that is capable of executing instructions, as further described herein. Controller 402 is in electrical, wireless, and/or logical communication with OTV array 420. OTV array 420 comprises the OTVs of hydrogen storage system 112, namely, OTVs 312, 320, 330, 340, and 350. As described above, OTVs 312, 320, 330, 340, and 350 each comprise an electronically actuated valve in fluid communication with each of tanks 302, 304, 306, 308, and 310 and manifold 360. In that regard, OTVs 312, 320, 330, 340, and 350 may selectively open and close electronically actuated valves and cause each of tanks 302, 304, 306, 308, and 310 to be in fluid communication with manifold 360 (i.e., opened electronically actuated valve) or to be fluidly isolated from manifold 360 (i.e., closed electronically actuated valve). Controller 402 is in electrical, wireless, and/or logical communication with regulator 370 and pressure sensor 383. In this manner, controller 402 may receive pressure information from regulator 370 that is indicative of the pressure in fuel cell supply line 373 and/or at manifold 360.

Controller 402 is in electrical, wireless, and/or logical communication with OTV temperature sensor array 408 (OTV temperature sensors 314, 322, 332, 342, and 352), EP pressure sensor array 406 (EP pressure sensors 318, 328, 338, 348, and 358), and EP temperature sensor array 404 (EP temperature sensors 316, 326, 336, 346, and 356). In various embodiments, controller 402 is in electrical, wireless, and/or logical communication with OTV pressure sensor array 406. OTV pressure sensor array 406 comprises the array of OTV pressure sensors associated with each of OTVs 312, 320, 330, 340, and 350, in various embodiments. Controller 402 is in electronic communication with control systems 440. Control systems 440 may include other controllers, processors, and other electronic devices that control aspects of various systems on FCEV 100. Control systems 440 may exist onboard FCEV 100 or may be remote from FCEV 100. Control systems 440 are in electronic communication and/or mechanical communication with mechanical systems 430. Mechanical systems 430 of FCEV 100 implement various driving functions, such as the braking system, the parking brake, the electric motor(s), onboard lights, onboard displays, and other similar systems.

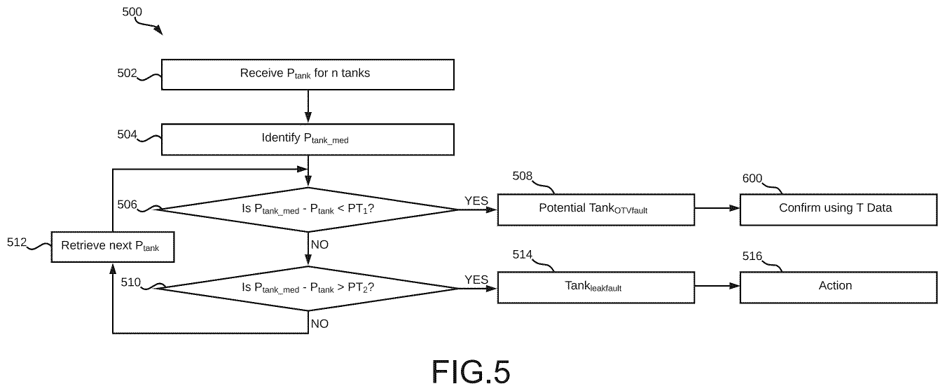

With reference to FIG. 5, hydrogen tank assembly diagnostic method 500 is illustrated. Hydrogen tank assembly diagnostic method 500 may be configured or utilized to monitor, identify, or assess one or more faults associated with tanks 302, 304, 306, 308, and 310 and/or related components such as OTVs 312, 320, 330, 340, and 350 and/or EPs 315, 324, 334, 344, and 354, and take action to mitigate safety, operability, or other concerns associated with the one or more faults. More particularly, in some embodiments, hydrogen tank assembly diagnostic method 500 may be configured or utilized to determine whether one or more of tanks 302, 304, 306, 308, and 310 is leaking and/or whether one or more of OTVs 312, 320, 330, 340, and 350 is in a stuck closed state and react accordingly.

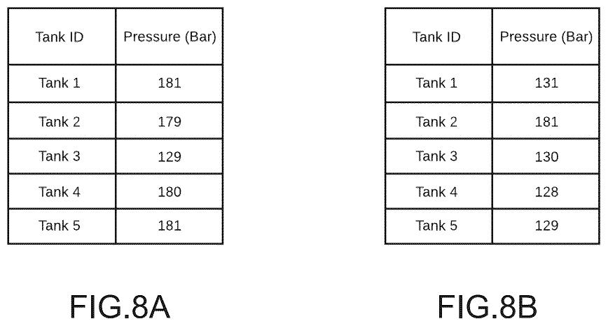

At step 502, controller 402 receives Pₜₐₙₖ for n tanks. Pₜₐₙₖ represents an internal pressure measurement associated with each tank in a tank assembly having n tanks. For example, receive Pₜₐₙₖ for n tanks may comprise receiving an internal pressure measurement for each of tanks 302, 304, 306, 308, and 310. In this case, n=5. It should be appreciated, however, that n may be any whole number corresponding to the number of hydrogen tanks included in the applicable hydrogen tank assembly or associated vehicle. As such, in various embodiments, n may be 1, 2, 3, 4, 5, 6, 7, 8, 9, 10, and so on. In various embodiments, step 502 comprises measuring Pₜₐₙₖ for each of n tanks (for example, 302, 304, 306, 308, and 310) using EP pressure sensors 318, 328, 338, 348, and 358 and/or pressure sensors associated with OTVs 312, 320, 330, 340, and 350. At step 502, controller 402 may further record the measured Pₜₐₙₖ for n tanks in memory in the form of a matrix, array, or table having one or more columns and/or one or more rows that may include a tank identifier (ID) and associated pressure value. FIGS. 8A and 8B illustrate exemplary pressure distributions for an exemplary hydrogen tank assembly having five tanks, and will be discussed in further detail below.

At step 504, controller 402 identifies P_{tank_med}, where P_{tank_med} represents the median Pₜₐₙₖ for n tanks. Stated otherwise, controller 402 may order the recorded Pₜₐₙₖ values in ascending or descending order and select the median Pₜₐₙₖ. In some embodiments, such as those where n is an even number, step 504 may comprise calculating a mean pressure value using two or more Pₜₐₙₖ values positioned closest to the middle of the order and recording that value as P_{tank_med}. In other embodiments, controller 402 calculates the mean Pₜₐₙₖ value using Pₜₐₙₖ from all tanks in the assembly and records that value as P_{tank_med}. In some embodiments, n corresponds to the number of tanks in the tank assembly devoid of faults or other operational constraints. For example, if a tank is damaged or otherwise unusable, a tank may be omitted from the count, and thus n may be a smaller number than the number of tanks physically present on a vehicle.

At step 506, controller 402 calculates a difference between P_{tank_med} and Pₜₐₙₖ associated with a given tank and compares the output with a first pressure threshold, PT₁. More specifically, at step 506, controller 402 compares the difference between P_{tank_med} and Pₜₐₙₖ with the first pressure threshold PT₁ and seeks to determine if the difference is less than PT₁. For the initial calculation, Pₜₐₙₖ may be the first Pₜₐₙₖ in the matrix, array, or table, last Pₜₐₙₖ in the matrix, array, or table, or any other Pₜₐₙₖ. In various embodiments, PT₁ may be a calibratable threshold value that may indicate a stuck closed OTV. More specifically, because each of the tanks (e.g., tanks 302, 304, 306, 308, and 310) are in fluid communication via plumbing system 384 when OTVs are open (such as when FCEV 100 is in run mode, as an example), it is expected that the internal pressure values of the tanks will be reasonably close or within PT₁ of each other. Further, the pressure is expected to drop at a similar rate for each of the tanks as the fuel cell system consumes hydrogen. However, if the difference between P_{tank_med} and Pₜₐₙₖ is less than PT₁, this may be indicative that the tank being evaluated has a disproportionally high pressure relative to the remaining tanks, which may mean that the relevant OTV has faulted (or is stuck) closed and pressure in the relevant tank has remained level, or even increased, as the pressures in the remaining tanks have decreased over time.

With momentary reference to FIG. 8B, a first exemplary pressure distribution for five tanks is illustrated. This pressure distribution indicates that the OTV associated with Tank 2 may be in a stuck closed state. More specifically, for this pressure distribution, the median tank pressure is the pressure of Tank 3 with a pressure of 130 bar. When controller 402 calculates the difference between P_{tank_med} (130 bar) and Pₜₐₙₖ (181 bar for Tank 2), the result is −51 bar, as compared to the result of −1 bar in the case of Tank 1. Given this difference (−51 bar) is less than the first pressure threshold PT₁ (which may be −20 bar, for example), it is determined that the OTV associated with Tank 2 may be stuck closed.

Returning to FIG. 5, in various embodiments, PT₁ may be between approximately 0 and 40 bar, between approximately 10 and 30 bar, or between approximately 15 and 25 bar. In some embodiments, PT₁ may be determined based on noise tolerances associated with EP pressure sensors 318, 328, 338, 348, and 358 and/or pressure sensors associated with OTVs 312, 320, 330, 340, and 350. In some embodiments, PT₁ may be dynamic and determined, in part, based on an instantaneous pressure and/or an average pressure over a time period at one or more locations of hydrogen storage system 112, such as fuel cell supply line 373, manifold 360, and/or plumbing system 384. In other words, in some embodiments, it may be expected that the variation in Pₜₐₙₖ between tanks may be greater for higher working pressures (e.g., 600 bar) than lower working pressures (e.g., 100 bar) and this may be reflected in the determination of PT₁. In some embodiments, PT₁ is calculated as a percentage of the instantaneous working pressures in the tanks, fuel cell supply line 373, manifold 360, and/or plumbing system 384, for example, between 5-25% of the instantaneous pressure, between 10-20% of the instantaneous pressure, or approximately 15% of the instantaneous pressure. If controller 402 determines that P_{tank_med}−Pₜₐₙₖ<PT₁, hydrogen tank assembly diagnostic method 500 moves to step 508 and identifies a potential OTV stuck closed fault (Tank_{OTVfault}) for the tank being evaluated.

In some embodiments, following the identification of a potential OTV stuck closed fault (step 508), hydrogen tank assembly diagnostic method 500 moves to step 600 to confirm the existence of the stuck closed fault by analyzing temperature data. In some situations, pressure data may be insufficient to rule out pressure outliers caused by factors other than a stuck closed OTV. For example, given the positioning of tanks 302, 304, 306, 308, and 310 in FCEV 100, one of the tanks may experience more heat than the other tanks, for example due to the tanks proximity to heat generating components, systems, or ambient sources. As an illustrative example, tank 306, which may be positioned between a fuel cell system and a high voltage battery system, may be the recipient of more radiative and convective heat transfer than tank 310, especially during times of high fuel cell power output and/or high voltage battery discharge or recharge. In turn, this increase in temperature may result in an increase in pressure in the applicable tank, potentially leading to a false positive OTV stuck closed fault identification.

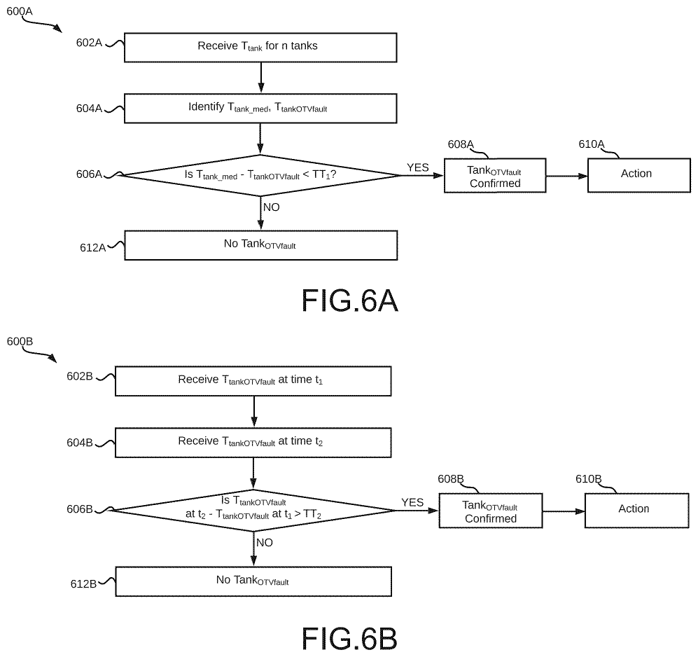

Accordingly, with reference to FIG. 6A, a method 600A for confirming the existence of a stuck closed OTV using temperature data is illustrated, in accordance with various embodiments. At step 602A, controller 402 receives Tₜₐₙₖ for n tanks. Tₜₐₙₖ represents an internal temperature measurement associated with each tank in a tank assembly having n tanks. For example, receiving Tₜₐₙₖ for n tanks may comprise receiving an internal temperature measurement for each of tanks 302, 304, 306, 308, and 310. In this case, n=5. It should be appreciated, however, that n may be any whole number depending on the number of hydrogen tanks included in the applicable hydrogen tank assembly or vehicle. As such, in various embodiments, n may be 1, 2, 3, 4, 5, 6, 7, 8, 9, 10, and so on. In various embodiments, step 502 comprises measuring Tₜₐₙₖ for each of n tanks (for example, 302, 304, 306, 308, and 310) using EP temperature sensors 316, 326, 336, 346, and 356 and/or OTV temperature sensors 314, 322, 332, 342, and 352. In some embodiments, Tₜₐₙₖ for each tank is determined by calculating the mean of temperature values received from EP temperature sensors and OTV temperature sensors. At step 602A, controller 402 may further record the measured and/or calculated Tₜₐₙₖ for n tanks in memory in the form of a matrix, array, or table having one or more columns and/or one or more rows that may include a tank identifier (ID) and associated temperature value.

At step 604A, controller 402 identifies T_{tank_med} and T_{tankOTVfault}, where T_{tank_med} represents the median Tₜₐₙₖ for n tanks and T_{tankOTVfault} represents the temperature associated with the tank identified as potentially having an OTV stuck closed fault in step 508 discussed above. Stated otherwise, controller 402 may order the recorded Tₜₐₙₖ values in ascending or descending order and select and store T_{tank_med} and T_{tankOTVfault}. In some embodiments, such as those where n is an even number, step 604A may comprise calculating a mean temperature value using two or more Tₜₐₙₖ values positioned closest to the middle of the order and recording that value as T_{tank_med}. In other embodiments, controller 402 calculates the mean Tₜₐₙₖ value using Tₜₐₙₖ from all tanks in the array and records that value as T_{tank_med}. In some embodiments, n corresponds to the number of tanks in the tank assembly devoid of faults or other operational constraints.

At step 606A, controller 402 calculates a difference between T_{tank_med} and T_{tankOTVfault} and compares the output with a first temperature threshold TT₁. More specifically, at step 606A, controller 402 compares the difference between T_{tank_med} and T_{tankOTVfault} with the first temperature threshold TT₁ and seeks to determine if the difference is less than TT₁. In various embodiments, TT₁ may be a calibratable threshold value that confirms a stuck closed OTV. More specifically, the first temperature threshold TT₁ may be selected such that it accounts for expected temperature differences between tanks, for example based at least in part on the positioning of the tanks in FCEV 100. In some embodiments, the first temperature threshold TT₁ may be dynamic and determined based on the ambient temperature and T_{tank_med}. In some embodiments, TT₁ may be a percentage of T_{tank_med}. In various embodiments, the first temperature threshold TT₁ may be between 5-25% of T_{tank_med}, between 10-20% of T_{tank_med}, or approximately 15% of T_{tank_med}. If the difference between T_{tank_med} and T_{tankOTVfault} is less than TT₁, this may indicate the tank with a potentially stuck closed OTV has a disproportionally high temperature relative to the remaining tanks, which may confirm that the relevant OTV has faulted (or is stuck) closed. In this case, controller 402 moves to step 608A and confirms the existence of the OTV stuck closed fault.

Following step 608A, method 600A moves to step 610A and controller 402 takes appropriate action in response to the identified fault. In the case of an OTV stuck closed fault, which may not be deemed to be safety critical, controller 402 may take actions such as: (i) alerting an operator of the fault via an audible or visual alert; (ii) recommend service be scheduled; (iii) reduce the displayed amount of fuel available for operation by subtracting the amount of fuel in the faulted tank from the total amount of fuel in all tanks (for example, via a vehicle head unit (VHU)); or take other actions that do not require immediate further response or action. Stated otherwise, the vehicle may continue to operate as usual despite the reduction in available fuel. In various embodiments, controller 402 may further communicate the OTV stuck closed fault to other vehicle controllers such as a vehicle control module (VCM) and/or VHU. If controller 402 instead determines that T_{tank_med}−T_{tankOTVfault}≥TT₁, method 600A moves to step 612A and determines that there is no OTV stuck closed fault.

In response to a determination that method 600A does not confirm the stuck closed OTV state identified in step 508, various actions may be taken in step 612A. In some embodiments, controller 402 repeats the aforementioned steps discussed in relation to FIGS. 5 and 6A to determine if a different result is reached. In the same or other embodiments, controller 402 attempts to identify faults with the various pressure and/or temperature sensors associated with the tank in question. In the same or other embodiments, controller 402 monitors the pressure and temperature of the tank in question to determine if tank pressure and temperature normalize over time. In the same or other embodiments, controller 402 proceeds to identify an OTV stuck closed fault, notwithstanding the lack of confirmation using temperature data.

With reference now to FIG. 6B, an alternative method 600B for confirming the existence of a stuck closed OTV using temperature data is illustrated, in accordance with various embodiments. In contrast to method 600A, which compares temperature data of a tank having a potentially stuck closed OTV fault with the median tank temperature in the tank assembly, method 600B seeks to confirm the existence of a fault by determining the direction and/or rate of change of temperature for the tank in question. In some embodiments, method 600B may be utilized in addition to method 600A, rather than an alternative method of confirming the presence of a stuck closed OTV. In other words, method 600B may begin at step 608A of method 600A in certain embodiments.

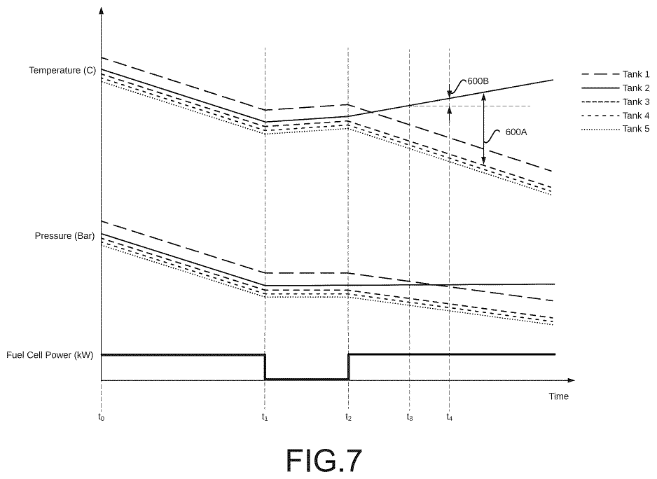

FIG. 7 is a simplified graph illustrating pressure and temperature changes in a hydrogen tank assembly over time. At time t₀, the fuel cell system is operational, and as a result, the OTVs open. As tanks 1-5 deliver hydrogen to the fuel cell system, the pressures and temperatures in the tanks progressively decrease at a substantially uniform rate. At time t₁, the vehicle is shut off and the OTVs close. In this example, it is assumed the ambient temperature is greater than the hydrogen temperature in the tanks, so the temperature in the tanks slowly increases to approach the ambient temperature. While not illustrated in this manner in FIG. 7, it can also be assumed that the pressures in the tanks also increase from t₁ to t₂ given the proportional relationship between pressure and temperature. At time t₂, the fuel cell vehicle is operational once again and the OTVs open. As expected, the pressures and temperatures of tanks 1 and 3-5 slowly decrease as hydrogen is delivered from the tanks to the fuel cell system. In contrast, the internal temperature of tank 2, which has a stuck closed OTV, continues to increase (positive rate of change) with time toward the ambient temperature. Method 600B aims to capture divergence such as this one.

Returning to FIG. 6B, at step 602B, controller 402 receives T_{tankOTVfault} at a first time, t₁ (for example, at time t₃ illustrated in FIG. 7). T_{tankOTVfault} represents the temperature of the tank identified as potentially having a stuck closed OTV in step 508. T_{tankOTVfault} may be measured and/or calculated consistent with method 600A discussed above. In various embodiments, the first time t₁ may be after the time a potentially stuck closed OTV fault was identified. In various embodiments, the time gap between the potentially stuck closed OTV fault identification and the first time t₁ may be determined based on the mass and/or volumetric flow rate of hydrogen to the fuel cell system and/or fuel cell system power output.

At step 604B, controller receives T_{tankOTVfault} at a second time t₂. In various embodiments, the second time t₂ may be after the first time t₁ (for example, time t₄ illustrated in FIG. 7). In various embodiments, the time between the first time t₁ and the second time t₂ may be determined based on the mass and/or volumetric flow rate of hydrogen to the fuel cell system and/or fuel cell system power output.

At step 606B, controller 402 calculates a difference between T_{tankOTVfault} at the second time t₂ and the first time t₁ and compares the output with a second temperature threshold TT₂. In various embodiments, TT₂ may be a calibratable threshold value that may confirm stuck closed OTV fault. More specifically, the second temperature threshold TT₂ may be selected such that it accounts for expected tank temperature fluctuations during normal operation. In some embodiments, the second temperature threshold TT₂ may be dynamic and determined based at least in part on the ambient temperature and T_{tank_med}. In some embodiments, TT₂ may be a percentage of T_{tank_med}. In various embodiments, the first temperature threshold TT₂ may be between 5-25% of T_{tank_med}, between 10-20% of T_{tank_med}, or approximately 15% of T_{tank_med}. In other embodiments, given that temperature of hydrogen in a tank is expected to decrease over time while an OTV is open, controller 402 may instead determine a sign of the difference. In other words, a positive pressure delta may indicate the temperature is rising with time, and therefore the OTV is stuck closed, whereas a negative pressure delta may indicate the OTV is not stuck closed. If controller 402 determines the difference between T_{tankOTVfault} at the second time t₂ and T_{tankOTVfault} at the first time t₁ is greater than the second temperature threshold TT₂, or controller 402 determines the difference is a positive value, controller 402 confirms the presence of an OTV stuck closed fault in step 608B and takes appropriate action in step 610B. Otherwise, controller 402 determines there is no OTV stuck closed fault in step 612B. The actions performed during steps 610B and 612B may be identical to the actions taken during steps 610A and 612A discussed above.

Returning now to FIG. 5, if instead controller 402 determines that P_{tank_med}−Pₜₐₙₖ>PT₁, controller 402 moves to step 510. At step 510, controller 402 calculates a difference between P_{tank_med} and Pₜₐₙₖ associated with the given tank and compares the output with a second pressure threshold, PT₂. More specifically, at step 510, controller 402 compares the difference between P_{tank_med} and Pₜₐₙₖ with the second pressure threshold PT₂ and seeks to determine if the difference is greater than PT₂. For the initial calculation, Pₜₐₙₖ may be the first Pₜₐₙₖ in the matrix or table, last Pₜₐₙₖ in the matrix or table, or any other Pₜₐₙₖ. In various embodiments, PT₂ may be a calibratable threshold value that may indicate the presence of a tank leak. More specifically, because each of the tanks (e.g., tanks 302, 304, 306, 308, and 310) are in fluid communication via plumbing system 384 when OTVs are open (such as in when FCEV 100 is in run mode, as an example), it is expected that the internal pressure values of the tanks will be reasonably close or within PT₂ of each other. Further, the pressure is expected to drop at a similar rate for each of the tanks as the fuel cell system consumes hydrogen. However, if the difference between P_{tank_med} and Pₜₐₙₖ is greater than PT₂, this may be indicative that the tank being evaluated has a disproportionally low pressure relative to the remaining tanks, which may mean that the relevant tank is leaking and pressure in the relevant tank has decreased at a rate greater than the remaining tanks over time.

With momentary reference to FIG. 8A, a second exemplary pressure distribution for five tanks is illustrated. This pressure distribution indicates that Tank 3 has a tank leak fault. More specifically, for this pressure distribution, the median tank pressure is Tank 4 with a pressure of 180 bar. When controller 402 calculates the difference between P_{tank_med} (180 bar) and Pₜₐₙₖ (129 bar for Tank 3), the result is 51 bar (as compared to 1 bar in the case of Tank 2). Given this difference (51 bar) is greater than the second pressure threshold PT₂ (which may be 15 bar, 20 bar, and/or 25 bar, for example), it is determined that Tank 3 may be leaking.

Returning to FIG. 5, in various embodiments, PT₂ may be between approximately 30 and 70 bar, between approximately 40 and 60 bar, or between approximately 45 and 55 bar. In some embodiments, PT₂ may be determined based on noise tolerances associated with EP pressure sensors 318, 328, 338, 348, and 358 and/or pressure sensors associated with OTVs 312, 320, 330, 340, and 350. In some embodiments, PT₂ may be determined, at least in part, based on an instantaneous pressure and/or an average pressure over a time period at one or more locations of hydrogen storage system 112, such as fuel cell supply line 373, manifold 360, and/or plumbing system 384. In other words, in some embodiments, it may be expected that the variation in Pₜₐₙₖ between tanks may be greater for higher working pressures (e.g., 600 bar) than lower working pressures (e.g., 100 bar) and this may be reflected in the determination of PT₂. In some embodiments, PT₂ is calculated as a percentage of the instantaneous working pressure in the tanks, fuel cell supply line 373, manifold 360, and/or plumbing system 384, for example, between 5-25% of the instantaneous pressure, between 10-20% of the instantaneous pressure, or approximately 15% of the instantaneous pressure.

If controller 402 determines that P_{tank_med}−Pₜₐₙₖ>PT₂, hydrogen tank assembly diagnostic method 500 moves to step 514 and identifies a tank leak fault for the tank being evaluated. Following step 514, hydrogen tank assembly diagnostic method 500 moves to step 516 and controller 402 takes appropriate action in response to the identified fault. In the case of a tank leak fault, which may be deemed to be safety critical, controller 402 may take actions such as: (i) alert the operator of the fault via an audible or visual alert, (ii) command one or more of OTVs 312, 320, 330, 340, and 350 closed, and/or (iii) directly or indirectly communicate with one or more processors to adjust the operation of FCEV 100. In various embodiments, controller 402 may further communicate the tank leak fault to other vehicle controllers such as the VCM and/or VHU. In some embodiments, controller 402 may communicate the fault status to the VCM, which in turn, may adjust the operating mode of FCEV 100 to a service mode (defined above) or a limp home mode (during which FCEV 100 operates only under battery power and not under fuel cell power). In some embodiments, controller 402 may directly or indirectly communicate the fault status to first responders or a fleet administrator. In some embodiments, controller 402 commands OTVs 312, 320, 330, 340, and 350 closed as a precautionary safety reaction. If controller 402 instead determines that P_{tank_med}−Pₜₐₙₖ≤PT₂, hydrogen tank assembly 500 moves to step 512 to select the next Pₜₐₙₖ and repeats steps 506-516 and 600 (to the extent applicable) for every tank in the tank assembly.

In various embodiments, hydrogen tank assembly diagnostic method 500 may be performed at routine intervals. For example, hydrogen tank assembly diagnostic method 500 may be performed once every 50 miles driven, once every 100 miles driven, once every 200 miles driven, and so on. In other embodiments, hydrogen tank assembly diagnostic method 500 may be performed at certain events, for example, at vehicle startup, transition to run mode, or park preparation mode. In some embodiments, hydrogen tank assembly diagnostic method 500 may performed at a time-based interval, for example, once every 30 minutes, once every hour, once every 4 hours, once a day, once a week, once a month, or other suitable interval.

The systems and methods described herein may be beneficial in identifying different faults associated with hydrogen tank assemblies using the same data, thereby reducing data processing and storage burdens. More particularly, the systems and methods described herein may be desirable over prior diagnostic methods, which may only be capable of identifying a single fault condition. In contrast, the present systems and methods permit identification of two distinct fault conditions, stuck closed OTVs and leaking tanks using a common data set. Further, in various embodiments, potentially stuck closed OTV faults identified using pressure data may be confirmed using temperature data. While discussed here as utilizing pressure data for initial fault identification and temperature data for confirmation, given the relationship between pressure and temperature, other embodiments may utilize the same or similar logic using temperature data for identification and pressure data for confirmation.

While the steps described in relation to FIGS. 5, 6A, and 6B may be performed in any desired sequence, it may be desirable to identify a tank leak fault (i.e., steps 510-516) prior to identification of a stuck closed OTV fault (i.e., steps 506-600) given a leaking tank may be considered safety critical. However, a leaking tank may be a rarer occurrence than a stuck closed OTV state, so in other embodiments, it may be prudent to identify a stuck closed OTV fault (i.e., steps 506-600) prior to identification of a tank leak fault (i.e., steps 510-516). Numerous embodiments and sequences of steps are contemplated in this regard.

Any of the systems and methods disclosed herein may be implemented with varying combinations of hardware, software, communications and/or networking interfaces, and various mechanical machinery including valve actuators, mechanical actuators, display devices, haptic feedback devices, and other hardware capable of receiving a command and converting electrical energy, in response to said command, into mechanical motion.

Computer programs (also referred to as computer control logic) are stored in main memory and/or secondary memory. Computer programs may also be received via communications interface. These computer program instructions may be loaded onto a general-purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hydrogen storage system for a fuel cell electric vehicle (FCEV), comprising:
a controller in electronic communication with a plurality of pressure sensors, each pressure sensor coupled to a hydrogen storage tank of a plurality of hydrogen storage tanks; and
a non-transitory computer-readable storage medium in electronic communication with the controller, having instructions stored thereon that, in response to execution by the controller, cause the controller to perform operations comprising:
receiving, by the controller, a plurality of pressure measurements from the plurality of pressure sensors;
determining, by the controller, a median pressure value of the plurality of pressure measurements;
calculating, by the controller, differences between the median pressure value and each pressure measurement of the plurality of pressure measurements;
in response to finding that at least one difference is less than a first pressure threshold, operating the controller to cause at least one of (i) providing an audible or visual alert, (ii) reducing a displayed amount of fuel available for operation of the FCEV by subtracting an amount of fuel in a hydrogen storage tank associated with the pressure sensor having the difference from the sum of the amount of fuel in the plurality of hydrogen storage tanks, or (iii) transmitting a stuck closed on tank valve (OTV) fault; and
in response to finding that at least one difference is greater than a second pressure threshold, operating the controller to cause at least one of (i) providing an audible or visual alert, (ii) commanding one or more OTVs to close, (iii) modifying an operation of the FCEV, or (iv) transmitting, by the controller, a tank leak fault.

2. The hydrogen storage system of claim 1, wherein each hydrogen storage tank of the plurality of hydrogen storage tanks comprises an end plug (EP) and an OTV.

3. The hydrogen storage system of claim 2, wherein the EP and the OTV are in fluid communication with an internal volume of the hydrogen storage tank.

4. The hydrogen storage system of claim 3, wherein the pressure sensor is included in at least one of the EP or the OTV.

5. The hydrogen storage system of claim 1, wherein the first pressure threshold is determined based on a pressure in at least one of a fuel cell supply line, a manifold, or a plumbing system.

6. The hydrogen storage system of claim 5, wherein the fuel cell supply line, the manifold, and the plumbing system are in fluid communication with the hydrogen storage tanks when OTVs coupled to the hydrogen storage tanks are open.

7. The hydrogen storage system of claim 1, wherein the operations further comprise communicating, by the controller, the stuck closed OTV fault or the tank leak fault to a second controller.

8. The hydrogen storage system of claim 7, wherein the second controller comprises one of a vehicle control module (VCM) or a vehicle head unit (VHU).

9. An article of manufacture including a tangible, non-transitory computer-readable storage medium in electronic communication with a controller, having instructions stored thereon that, in response to execution by the controller, cause the controller to perform operations comprising:
receiving, by the controller, a plurality of pressure measurements from a plurality of pressure sensors, each pressure sensor coupled to a hydrogen storage tank of a plurality of hydrogen storage tanks;
determining, by the controller, a median pressure value of the plurality of pressure measurements;
calculating, by the controller, differences between the median pressure value and each pressure measurement of the plurality of pressure measurements;
determining, by the controller, the absolute value of the difference between the first pressure and the second pressure to yield an absolute pressure difference;
in response to finding that at least one difference is less than a first pressure threshold, operating the controller to cause at least one of (i) providing an audible or visual alert, (ii) reducing a displayed amount of fuel available for operation of the FCEV by subtracting an amount of fuel in a hydrogen storage tank associated with the pressure sensor having the difference from the sum of the amount of fuel in the plurality of hydrogen storage tanks, or (iii) transmitting a stuck closed on tank valve (OTV) fault; and
in response to finding that at least one difference is greater than a second pressure threshold, operating the controller to cause at least one of (i) providing an audible or visual alert, (ii) commanding one or more OTVs to a closed position, (iii) modifying an operation of the FCEV, or (iv) transmitting, by the controller, a tank leak fault.

10. The article of manufacture of claim 9, wherein the operations further comprise communicating, by the controller, an audible or visual alert to an operator in response to the stuck closed OTV fault.

11. £ The article of manufacture of claim 9, wherein an OTV is fluidly coupled to each hydrogen storage tank.

12. The article of manufacture of claim 11, wherein the instructions further comprise commanding, by the controller, each OTV to a closed position in response to the tank leak fault.

13. The article of manufacture of claim 9, wherein determining the median pressure value of the plurality of pressure measurements comprises calculating a mean pressure value of a first pressure measurement and a second pressure measurement when the plurality of hydrogen storage tanks comprises an even number of tanks.

14. The article of manufacture of claim 9, wherein the plurality of hydrogen storage tanks comprises five hydrogen storage tanks.

15. A method, comprising:
receiving, by a controller, a plurality of pressure measurements from a plurality of pressure sensors, each pressure sensor coupled to a hydrogen storage tank of a plurality of hydrogen storage tanks;
determining, by the controller, a median pressure value of the plurality of pressure measurements;
calculating, by the controller, differences between the median pressure value and each pressure measurement of the plurality of pressure measurements;
determining, by the controller, the absolute value of the difference between the first pressure and the second pressure to yield an absolute pressure difference;
in response to finding that at least one difference is less than a first pressure threshold, operating the controller to cause at least one of (i) providing an audible or visual alert, (ii) reducing a displayed amount of fuel in the plurality of hydrogen storage tanks by subtracting an amount of fuel in a hydrogen storage tank associated with the pressure sensor having the difference from the sum of the amount of fuel in the plurality of hydrogen storage tanks, or (iii) transmitting a stuck closed on tank valve (OTV) fault; and
in response to finding that at least one difference is greater than a second pressure threshold, operating the controller to cause at least one of (i) providing an audible or visual alert, (ii) commanding one or more OTVs to a closed position, (iii) modifying an operation of a fuel cell electric vehicle (FCEV) having the plurality of hydrogen storage tanks coupled thereto, or (iv) transmitting, by the controller, a tank leak fault.

16. The method of claim 15, further comprising communicating, by the controller, the stuck closed OTV fault or the tank leak fault to a second controller.

17. The method of claim 16, wherein the second controller comprises at least one of a vehicle control module (VCM) or a vehicle head unit (VHU).

18. The method of claim 15, further comprising commanding, by the controller, a plurality of OTVs associated with the plurality of hydrogen storage tanks to closed positions in response to the tank leak fault.

19. The method of claim 17, further comprising updating, by the VHU, an amount of fuel available based on a fuel remaining in the tank having the stuck closed OTV fault.

20. The method of claim 17, further comprising, changing, by the VCM, an operating mode of a vehicle comprising the plurality of hydrogen storage tanks in response to the tank leak fault.
